(19) United States
(12) Patent Application Publication
(10) Pub. No.: US 2025/0027787 A1
(43) Pub. Date: Jan. 23, 2025

(54) METHOD AND APPARATUS FOR DETERMINING RELATIVE ELEVATION OF ROAD, DEVICE, STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Tongxing XIAO, Shenzhen (CN)

(21) Appl. No.: 18/906,284

(22) Filed: Oct. 4, 2024

Related U.S. Application Data
(63) Continuation of application No. PCT/CN2023/130961, filed on Nov. 10, 2023.

(30) Foreign Application Priority Data
Dec. 26, 2022 (CN) 202211672670.9

(51) Int. Cl. G01C 21/00

(52) U.S. Cl. CPC G01C 21/3822

(57) ABSTRACT

This application provides a method and an apparatus for determining a relative elevation of a road, an electronic device, a computer-readable storage medium, and a computer program product, which can be applied to the fields of maps, traffic, or autonomous driving. The method includes grouping a plurality of roads in a target area into at least one overlapping road group according to a relative position relationship between the roads in the target area, each of the overlapping road groups comprising at least two roads in the target area having an overlapping relationship; determining a high-low relationship between different roads in each overlapping road group; and determining a relative elevation of each road in each overlapping road group based on the high-low relationship between the different roads in each overlapping road group.

### RELATED APPLICATIONS

This application is a continuation of PCT Application No. PCT/CN2023/13061, filed on Nov. 10, 2023, which claims priority to Chinese Patent Application 202211672670.9, filed on Dec. 26, 2022. The two applications are incorporated by reference in their entirety.

### FIELD OF THE TECHNOLOGY

This application relates to the field of map technologies, and in particular, to a method and an apparatus for determining a relative elevation of a road, an electronic device, a computer-readable storage medium, and a computer program product.

### BACKGROUND OF THE DISCLOSURE

With the development of cities and roads, traffic has become more and more complex, and people often need to use electronic maps to complete route planning, route navigation, or the like. Because two-dimensional electronic maps (including two-dimensional information of roads, that is, longitude information and latitude information) cannot visually display spatial distribution of overpasses and viaducts, the demand for a three-dimensional electronic map including longitude information, latitude information, and height information of roads has become obvious.

To generate relative elevation data for navigation in an area, in the related art, absolute elevation data of all roads in the area needs to be collected first, and then the absolute elevation data of all the roads needs to be converted into relative elevation data. However, due to the large amount of calculation involved in this process and the complexity of the calculation, the calculation efficiency of the relative elevation data is low, often consuming large amount of computing resources.

### SUMMARY

Embodiments of this application provides a method and an apparatus for determining a relative elevation of a road, an electronic device, a computer-readable storage medium, and a computer program product, which can improve the calculation efficiency of the relative elevation of the road and the utilization rate of device resources.

Technical solutions in the embodiments of this application are implemented as follows:

An embodiment of this application provides a method for determining a relative elevation of a road, The method includes grouping a plurality of roads in a target area into at least one overlapping road group according to a relative position relationship between the roads in the target area, each of the overlapping road groups comprising at least two roads in the target area having an overlapping relationship; determining a high-low relationship between different roads in each overlapping road group; and determining a relative elevation of each road in each overlapping road group based on the high-low relationship between the different roads in each overlapping road group.

An embodiment of this application provides an electronic device, the electronic device including a memory, configured to store a computer-executable instruction; and a processor, configured to implement, when executing the computer-executable instruction stored in the memory, a method for determining a relative elevation of a road provided in the embodiments of this application.

An embodiment of this application provides a non-transitory computer-readable storage medium, having a computer-executable instruction stored therein, and the computer-executable instruction implementing, when executed by a processor, a method for determining a relative elevation of a road provided in the embodiments of this application.

The embodiments of this application have the following beneficial effects:

In embodiments of this application, a plurality of roads in a target area are grouped into a plurality of overlapping road groups according to a relative position relationship between the roads in the target area; and then, for each overlapping road group, a high-low relationship between different roads within the group is determined, and a relative elevation of a road in each overlapping road group is determined based on the high-low relationship between the different roads in each overlapping road group. Accordingly, by performing grouping of overlapping road groups on the roads in the target area and calculating a relative elevation of a road for each overlapping road group, the calculation amount and the calculation complexity for determining the relative elevation of the road are reduced. Therefore, the occupation of the calculation resources is reduced, and the efficiency of calculating the relative elevation of the road and the utilization rate of the device resources are improved.

### BRIEF DESCRIPTION OF THE DRAWINGS

FIG. 1 is a schematic diagram of an architecture of a system 100 for a method for determining a relative elevation of a road according to an embodiment of this application.

FIG. 2 is schematic structural diagram of an electronic device 500 for implementing a method for determining a relative elevation of a road according to an embodiment of this application.

FIG. 3 is a schematic flowchart of a method for determining a relative elevation of a road according to an embodiment of this application.

FIG. 4 is a schematic diagram of a road section having overlapping relationships according to an embodiment of this application.

FIG. 5 is a schematic diagram of a overlapping road group according to an embodiment of this application.

FIG. 6 is a flowchart of determining a relative elevation of a target road according to an embodiment of this application.

FIG. 7 is a flowchart of determining a value of a target element according to an embodiment of this application.

FIG. 8 is a flowchart of determining a value of a target element according to an embodiment of this application.

FIG. 9 is another flowchart of determining a value of a target element according to an embodiment of this application.

FIG. 10 is a flowchart of a method for updating a relative elevation of an abnormal road according to an embodiment of this application.

FIG. 11 is a flowchart of determining a value of a target element according to an embodiment of this application.

FIG. 12 is a flowchart of a method for determining correlated road endpoints according to an embodiment of this application.

FIG. 13 is a flowchart of a method for updating an overlapping road group according to an embodiment of this application.

FIG. 14A is a schematic diagram of directly-connected overlapping road groups according to an embodiment of this application.

FIG. 14B is a schematic diagram of a method for fusing overlapping road groups according to an embodiment of this application.

FIG. 15 is a flowchart of obtaining a fused overlapping road group according to an embodiment of this application.

FIG. 16 is a flowchart of a method for determining a relative elevation of an ungrouped road according to an embodiment of this application.

FIG. 17 is a flowchart of a method for determining a relative elevation of a grouped road according to an embodiment of this application.

FIG. 18 is a schematic diagram of high-low relationships of roads in a overlapping road group according to an embodiment of this application.

FIG. 19 is a flowchart of a method for determining a relative elevation of a road according to an embodiment of this application.

FIG. 20 is a schematic diagram of a method for determining an elevation through interpolation according to an embodiment of this application.

FIG. 21 is an overall flowchart of a convergence strategy according to an embodiment of this application.

FIG. 22 is a flowchart for a method for traversing back along a source endpoint according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but “some embodiments” may be the same subset or different subsets of all the possible embodiments, and can be combined with each other without conflict.

In the following descriptions, the terms “first/second/third” are only used to distinguish similar objects and do not represent specific sorting of objects. The terms “first/second/third” can be interchanged in specific order or sequence, if allowed, to enable the embodiments described herein to be implemented in order other than those illustrated or described herein.

Unless otherwise defined, meanings of all technical and scientific terms used in this specification are the same as those usually understood by a person skilled in the art to which this application belongs. The terms used in the specification of this application are merely intended to describe objectives of the embodiments, but are not intended to limit this application.

Before the embodiments of this application are further described in detail, a description is made on nouns and terms in the embodiments of this application, and the nouns and terms in the embodiments of this application are applicable to the following explanations.

1) Absolute elevation: It refers to a distance from a point on a road to an absolute base plane in a plumb line direction. For example, in the field of three-dimensional maps, the absolute base plane may be a sea-level altitude, and the absolute elevation of a point on a road may be a height of that point to the sea level in the plumb line direction.

2) Relative elevation (indicated by P): It is also referred to as virtual elevation and refers to a height of a road relative to the ground displayed in a three-dimensional mode in a plane map. The relative elevation refers to a distance from a point to a particular assumed reference base plane in a plumb line direction, and is also referred to as an assumed elevation. In this application, the relative elevation of a road is considered to be a height difference between each point on the road and the ground, and the set reference base plane is the ground.

3) Road section: It refers to a segment representation of a road in a plane map, and each road segment is a road section.

4) Road center line: It refers to an axis of symmetry in an extension direction of a road section.

5) Road points: They refer to a series of points on a road center line after a road section is represented by using a road center line, and the number of the points can be set in advance.

6) Topological relationship: It refers to a topological relationship between a road section and its preceding road section or its following road section if the preceding road section or the following road section exists.

Connection relationship: It refers to a connection relationship between different road sections. For example, for a road section in which a preceding road section or a following road section exists, a relationship between the road section and the preceding road section or the following road section is a connection relationship. The connection relationship may further include a diversion relationship and a convergence relationship.

The diversion relationship means that if two road sections have a same preceding road section, there is a diversion relationship between the two road sections. The convergence relationship means that if two road sections have the same following road section, there is a convergence relationship between the two road sections.

7) Overlapping relationship: It means that two road sections do not belong to a same road plane and there is an interval in space. For example, if a road section is above another road section, the two road sections have an overlapping relationship, and the road section above covers the road section below in a overlapping mode. A overlapping road group can be obtained by grouping roads according to an overlapping relationship. The overlapping road group is specifically defined in the following. For any road in the group, there is at least another road in a overlapping relationship therewith, and these roads are located in a same overlapping group.

8) Reference elevation: It refers to a height of a road section relative to the ground determined according to a road attribute of the road section. For example, the reference elevation of an ordinary road is usually 0 meters, and the reference elevation of an overpass road is usually 3.5 meters.

9) Preset slope: A slope that meets road construction specifications, usually small, such as 3°.

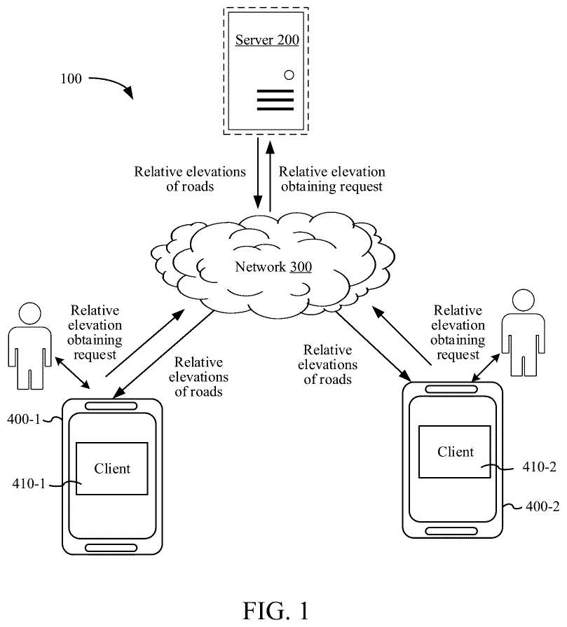

Based on the foregoing explanations of the nouns and terms involved in the embodiments of this application, the following describes a system for determining a relative elevation of a road according to the embodiments of this application. FIG. 1 is a schematic diagram of an architecture of a system 100 for determining a relative elevation of a road according to an embodiment of this application. To implement supporting of an exemplary application, terminals (a terminal 400-1 and a terminal 400-2 are illustratively shown) are connected to a server 200 through a network 300. The network 300 may be a wide area network or a local area network, or a combination of the wide area network and the local area network. Data transmission is implemented by using a wireless or wired link.

In some embodiments, the terminals (for example, the terminal 400-1 and the terminal 400-2) may be deployed with clients supporting an electronic map function, and the terminals are configured to transmit relative elevation obtaining requests for relative elevations of roads in a target area to the server 200, receive the relative elevations of the roads in the target area returned by the server 200, and display the relative elevations on the clients.

In some embodiments, the server 200 is configured to group a plurality of roads in the target area into at least one overlapping road group according to relative position relationships between the roads in the target area in response to a relative elevation obtaining request upon receipt of the relative elevation obtaining request transmitted by a terminal, each of the overlapping road groups including: at least two roads in the target area having a overlapping relationship; determine a high-low relationship between different roads in each overlapping road group; and determine a relative elevation of each road in each overlapping road group based on the high-low relationship between the different roads in each overlapping road group, and return the relative elevation of each road to the terminal.

In one embodiment, the server 200 may be an independent physical server, or a server cluster or distributed system composed of a plurality of physical servers, or may be a cloud server that provides cloud services, cloud databases, and basic cloud services such as cloud computing, cloud functions, cloud storage, network services, cloud communications, middleware services, domain name services, security services, content delivery networks (CDNs), big data, and artificial intelligence platforms. The terminals (for example, the terminal 400-1 and the terminal 400-2) may be, but are not limited to: smartphones, tablets, laptops, desktop computers, smart speakers, smart TV sets, smartwatches, or the like.

The embodiments of this application may be implemented by using the cloud technology, which refers to a hosting technology that unifies series of resources such as hardware, software, and network in a wide area network or a local area network, to implement computing, storage, processing, and sharing of data.

The cloud technology is a generic term for a network technology, an information technology, an integration technology, a management platform technology, an application technology, and the like applied based on a cloud computing commercial mode, and can form a pool of resources, which is used on demand and is flexible and convenient. The cloud computing technology is an important support. Backend services of a technology network system require a huge amount of computing and storage resources.

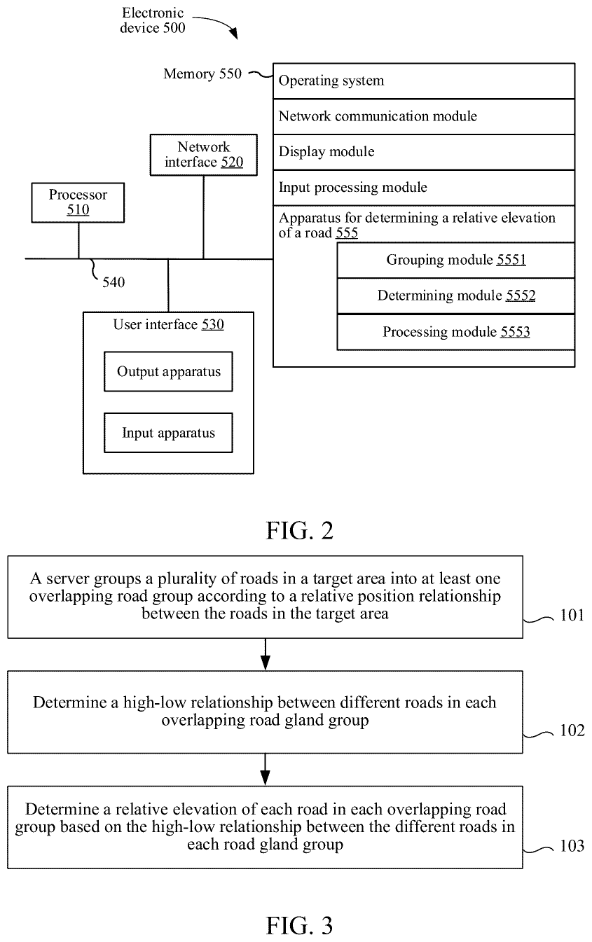

The following describes an electronic device for implementing the method for determining a relative elevation of a road according to an embodiment of this application. FIG. 2 is schematic structural diagram of an electronic device 500 for implementing a method for determining a relative elevation of a road according to an embodiment of this application. The electronic device 500 may be the server 200 shown in FIG. 1, and the electronic device 500 may alternatively be a terminal capable of implementing the method for determining a relative elevation of a road provided in this application. For example, the electronic device 500 is the server shown in FIG. 1. The following describes an electronic device for implementing a method for determining a relative elevation of a road in an embodiment of this application. The electronic device 500 provided in this embodiment of this application includes: at least one processor 510, a memory 550, at least one network interface 520, and a user interface 530. Components in the electronic device 500 are coupled together by using a bus system 540. The bus system 540 is configured to implement connection and communication between the components. In addition to a data bus, the bus system 540 further includes a power supply bus, a control bus, and a state signal bus. However, for ease of clear description, all types of buses in FIG. 2 are marked as the bus system 540.

In some embodiments, the apparatus for determining a relative elevation of a road provided in this embodiment of this application may be implemented in a software manner. FIG. 2 illustrates an apparatus 555 stored in the memory 550 and for implementing the method for determining a relative elevation of a road, which may be software in the form of a program, a plug-in, or the like, including the following software modules: a grouping module 5551, a determining module 5552, and a processing module 5553; these modules are logical and therefore can be combined or further divided according to functions to be implemented. The functions of the modules are described in the following.

In some other embodiments, the apparatus for implementing the method for determining a relative elevation of a road provided in the embodiments of this application may be implemented in a combination of software and hardware. In an example, the apparatus for implementing the method for determining a relative elevation of a road provided in the embodiments of this application may be a processor in form of a hardware decoding processor, which is programmed to perform the method for determining a relative elevation of a road provided in the embodiments of this application. For example, the processor in form of a hardware decoding processor may use one or more application specific integrated circuits (ASIC), a digital signal processor (DSP), a programmable logic device (PLD), a complex programmable logic device (CPLD), a field-programmable gate arrays (FPGA), or other electronic components.

In some embodiments, the terminal or the server may implement the method for determining a relative elevation of a road provided in the embodiments of this application by running a computer program. For example, a computer program can be a native program or software module in an operating system; may be a native application (APP), that is, a program that can run after being installed in the operating system, for example, an instant messaging APP or a web browser APP; or may be an applet, that is, an application that can run only after being downloaded to a browser environment; or may be an applet that can be embedded into any APP. To sum up, the computer program may be any form of application, module, or plug-in.

Based on the foregoing descriptions of the system and the electronic device for determining a relative elevation of a road provided in the embodiments of this application, the following describes the method for determining a relative elevation of a road provided in the embodiments of this application. In some embodiments, the method for determining a relative elevation of a road provided may be implemented independently by a terminal or a server, or may be implemented by a terminal and a server coordinately. A description is provided by an example in which the server 200 in FIG. 1 independently performs the method for determining a relative elevation of a road provided in the embodiments of this application. FIG. 3 is a schematic flowchart of a method for determining a relative elevation of a road according to an embodiment of this application. A description is provided in combination with the operations shown in FIG. 3.

Operation 101: A server groups a plurality of roads in a target area into at least one overlapping road group according to a relative position relationship between the roads in the target area,
each of the overlapping road groups including: at least two roads in the target area having a overlapping relationship.

In some embodiments, the server obtains two-dimensional road network data of the target area, and parses the two-dimensional road network data, to obtain the relative position relationship between the roads in the target area. The relative position relationship here includes an overlapping relationship, a diversion relationship, a convergence relationship, or the like.

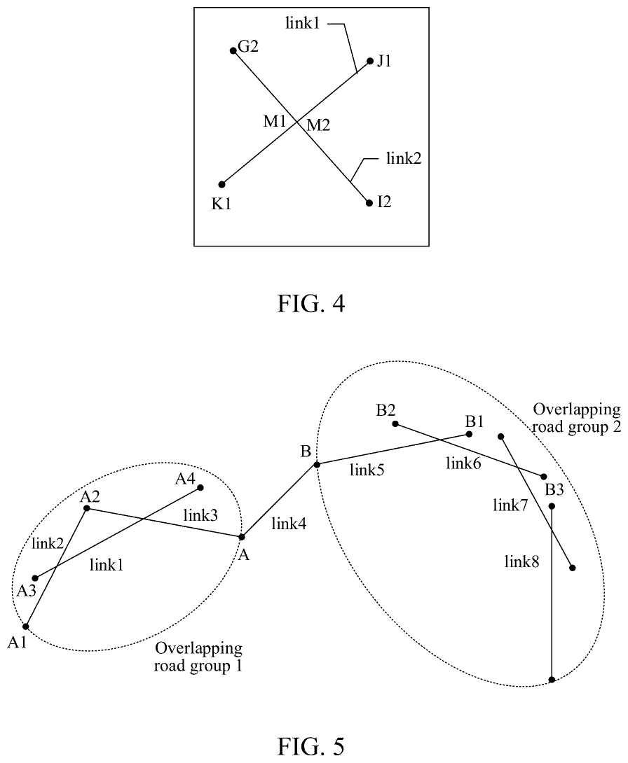

For example, FIG. 4 is a schematic diagram of a road section having overlapping relationships according to an embodiment of this application. A two-dimensional road network includes a road section link1 and a road section link2, where there is an overlapping relationship between the road section link1 and the road section link2, which is specifically manifested in that there is an intersection between a road point M1 of the road section link1 and a road point M2 of the road section link2 on a two-dimensional plane, and the road point M1 and the road point M2 have a high-low relationship (up-down relationship), that is, relative elevations corresponding to the two road points are different, as shown in FIG. 4, P(M1)>P(M2). Navigation data in the embodiments of this application does not provide elevation data of the roads, and therefore it does not provide elevation data of road points in the roads, but when the two road points are overlapping points to each other, it provides an up-down relationship of the two position points that are overlapping points, that is, both P(M1) and P(M2) are unknown, but a relationship between P(M1) and P(M2) can be determined, where P(M1) represents a relative elevation corresponding to the position point M1 of the road section link1 and P(M2) represents a relative elevation corresponding to the position point M2 of the road section link2.

In some embodiments, to quickly determine relative elevations of the roads in the target area, the server usually clusters the roads according to overlapping relationships, to obtain one or more overlapping road groups. For any road included in the overlapping road group, there is certainly a road having a overlapping relationship with the road in the overlapping road group; and there are no roads having a overlapping relationship between any two overlapping road groups. Accordingly, by performing grouping of overlapping road groups on the roads in the target area and calculating a relative elevation of a road for each overlapping road group, the calculation amount and the calculation complexity are reduced. Therefore, the occupation of the calculation resources is reduced, and the calculation efficiency and the utilization rate of the device resources are improved. The calculation accuracy of the relative elevation of the road is increased while the calculation amount and the calculation complexity are reduced.

Operation 102: Determine a high-low relationship between different roads in each overlapping road group.

The roads in the embodiments of this application are represented by road segments; each road segment is a road section, and the roads each include at least one road section, for example, road sections AA2, A1A2, A3A4 in FIG. 5. In some embodiments, the following processing is performed for each overlapping road group. The server obtains high-low relationships of all road sections in the overlapping road group. As shown in FIG. 4, the road section link1 at the road point M1 has an overlapping relationship with the road section link2 at the road point M2. The road point M1 and the road point M2 have a high-low relationship (up-down relationship), that is, the relative elevations corresponding to the road point M1 and the road point M2 are different, where P(M1)>P(M2). Therefore, the road section link1 and the road section link2 have a high-low relationship, that is, the road section link1 is higher than the road section link2.

Operation 103: Determine a relative elevation of each road in each overlapping road group based on the high-low relationship between the different roads in each overlapping road group.

In some embodiments, when the target area corresponds to a plurality of overlapping road groups, for each overlapping road group, the server determines the relative elevation of each road in the overlapping road group according to the determined high-low relationship between the different roads. In some embodiments, the determining of the relative elevation of each road in the plurality of overlapping road groups may be implemented by parallel processing, that is, determining a relative elevation of each road in each overlapping road group based on the high-low relationship between the different roads in each overlapping road group by using a parallel processing method between the overlapping road groups. That is, when there are N (N≥1 and N is an integer) overlapping road groups in the target area, the server may determine relative elevations of roads in each overlapping road group by using N parallel threads, so as to improve the calculation efficiency of the relative elevations and the utilization rate of device resources. In this embodiment of this application, for each overlapping road group, the server may convert the problem of generating a relative elevation of a road into a mathematical optimization problem by using the high-low relationship of the roads in the current overlapping road group, so that high-quality road relative elevation data can be generated at low costs.

The following describes the process of determining a relative elevation of a road in each overlapping road group. In some embodiments, FIG. 17 is a flowchart of a method for determining a relative elevation of a grouped road according to an embodiment of this application. A description is provided in combination with the operations shown in FIG. 17.

Operation 801: A server obtains a height constraint condition, a slope constraint condition, and a height continuity condition, where

the height constraint condition is configured for indicating a condition that an elevation difference between different roads needs to meet; the slope constraint condition is configured for indicating a condition that a slope of each road needs to meet; and the height continuity condition is configured for indicating a condition that continuity of adjacent roads needs to meet.

In some embodiments, the server may generate a relative elevation constraint condition based on a position correlation between at least two road points included in each road section in the two-dimensional road network, where the relative elevation constraint condition includes at least one of the following: a height constraint condition, a slope constraint condition, or a height continuity condition. The height constraint condition refers to a high-low relationship of a plurality of roads having overlapping relationships included in two-dimensional road network data obtained by the server, but does not provide a value of a height difference of two roads at overlapping positions. During generation of the relative elevation, the height difference between the two roads at the overlapping regions cannot be excessively small, or otherwise the overlapping regions look like overlapping each other during visualized display on a terminal, which affects the visual effect. Therefore, a minimum height difference at the overlapping positions of the two roads having a overlapping relationship needs to be controlled. The slope constraint condition means performing constraint on a road slope, and the generated relative elevation needs to meet that a road slope change is gentle and the road slope cannot rise or fall sharply. Therefore, the largest value of the road slope needs to be controlled. The height continuity condition means performing constraint on the height continuity at adjacent points. For two successively connected roads, the roads are required to be continuous at the adjacent points, or otherwise a sharp change in the height may occur at the adjacent points, that is, one road is high and one road low, which affects the visual effect.

Operation 802: Obtain a slope of each road in the overlapping road group, and determine a relative elevation of each road in the overlapping road group based on a slope, a high-low relationship, a height constraint condition, a slope constraint condition, and a height continuity condition.

In some embodiments, the server may construct the height constraint condition according to the high-low relationship of the roads in the overlapping road group; construct the height continuity condition of the two roads at the adjacent points according to the road topological relationship; construct the slope constraint condition between any two adjacent road points on each road according to the slope of each road in the overlapping road group; therefore obtain relative elevations of all the road endpoints according to a solution optimization problem based on the constructed height constraint condition, slope constraint condition, and height continuity condition; and further perform the following processing on each road: determining a relative elevation of another road point (different from the road endpoint) in the road by using an interpolation calculation method based on the relative elevations of the road endpoints of the road. Accordingly, the relative elevations of the road points (including the road endpoints) in the road constitute the relative elevation of the road.

By applying operation 801 to operation 802, the relative elevation of each road in the overlapping road group is determined based on the high-low relationships between the different roads in the overlapping road group in combination with the height constraint condition, the slope constraint condition, and the height continuity condition. Moreover, by using the height constraint condition, the minimum height difference between the two roads having a overlapping relationship at the overlapping positions can be constrained, so that during visualized display in navigation, the display effect at the overlapping positions is improved and the visual effect of overlapping at the overlapping positions is avoided; by using the slope constraint condition, constraints can be performed on the road slope, so that the generated relative elevation needs to meet that a road slope change is gentle, sharp rise or fall of the road slope is avoided, and further the navigation visualization effect is improved; and by using the height continuity condition, constraints can be performed on the high continuity at the adjacent points, and for the two successively connected roads, the roads are required to be continuous at the adjacent points, so that a sharp change at the adjacent points is avoided, and further the navigation visualization effect is improved.

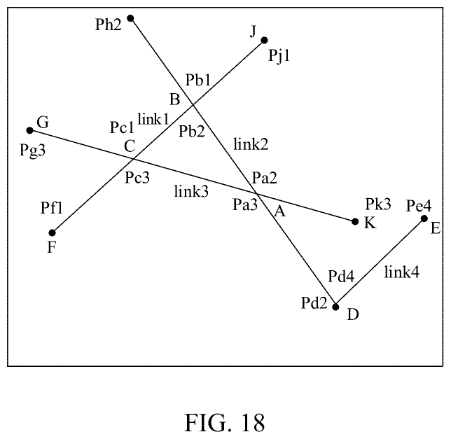

For example, FIG. 18 is a schematic diagram of high-low relationships of roads in a overlapping road group according to an embodiment of this application. In FIG. 18, there are four roads, where link1, link2, and link3 intersect at points A, B, and C respectively, and link2 and link4 are adjacent to each other at a point D. Assuming that the link2 is higher than the link3 at the point A, the link1 is higher than the link2 at the point B, and the link1 is higher than the link3 at the point C, the height constraint condition needs to be as follows:

$${P}_{a2} - {P}_{a 3} > h ; {P}_{b 1} - {P}_{b 2} > h ; {P}_{c 1} - {P}_{a 3} > h ,$$

h is a minimum height difference, it has been found in tests that the minimum height difference of 4 meters is more probable, and an excessively large value of the minimum height difference may lead to a result of no solution for the optimization problem.

If the link2 and the link4 adjoin at the point D, the height continuity condition is:

$${P}_{d 2} - {P}_{d 4} = 0.$$

The link1 is divided into three road sections, namely, FC, CB, and BJ by the point B and the point C, and each road section needs to meet the slope constraint condition, that is,

$${( {P}_{f 1} - {P}_{c 1} )}^{2} < {s}^{2} {d}_{fc}^{2} ; {( {P}_{c 1} - {P}_{b 1} )}^{2} < {s}^{2} {d}_{cb}^{2} ; {( {P}_{b 1} - {P}_{j 1} )}^{2} < {s}^{2} {d}_{bj}^{2} ,$$

where

s is a tangent value of a maximum slope, it has been found in tests that the maximum slope of 1° (1/180°) is more probable, and d_{fc}, d_{cb}, and d_{bj} are respectively planar distances between the point F and the point C, between the point C and the point B, and between the point B and the point J. These planar distances can be calculated after latitude and longitude coordinates to the road points are known, and are therefore known quantities.

Similarly, for the link2, each road section needs to meet the slope constraint condition:

$${( {P}_{h 2} - {P}_{b 2} )}^{2} < {s}^{2} {d}_{hb}^{2} ; {( {P}_{2} - {P}_{a 2} )}^{2} < {s}^{2} {d}_{ba}^{2} ; {( {P}_{a 2} - {P}_{d 2} )}^{2} < {s}^{2} {d}_{ad}^{2} .$$

For the link3, each road section needs to meet the slope constraint condition:

$${( {P}_{g 3} - {P}_{c 3} )}^{2} < {s}^{2} {d}_{g c}^{2} ; {( {P}_{c 3} - {P}_{a 3} )}^{2} < {s}^{2} {d}_{c a}^{2} ; {( {P}_{a 3} - {P}_{k 3} )}^{2} < {s}^{2} {d}_{a k}^{2} .$$

Based on the above, the problem of solving the relative elevations of the roads, namely, the link1, the link2, the link3, and the link4 in the overlapping road group is converted into the problem of solving a minimum value of a target function V:

$$V = {P}_{f 1}^{2} + {P}_{g 3}^{2} + {P}_{c 3}^{2} + {P}_{c 1}^{2} + {P}_{h 2}^{2} + {P}_{j 1}^{2} + {P}_{g 3}^{2} + {P}_{b 1}^{2} + {P}_{b 2}^{2} + {P}_{a 2}^{2} + {P}_{a 3}^{2} + {P}_{k 3}^{2} + {P}_{d 2}^{2} + {P}_{d 4}^{2} + {P}_{e 4}^{2} .$$

That is, the relative elevations of all the road points are solved, so that the target function V reaches the minimum values, and meanwhile the foregoing height constraint condition, the slope constraint condition, and the height continuity condition are met. The foregoing resolving of the minimum value of the target function V can be performed by using an inner point method in convex optimization. After the relative elevations of all the road endpoints are calculated, the relative elevations of the other road points of the road section are determined in an interpolation calculation method. For example, for the link1, after the relative elevation between the point C and the point F is calculated, relative elevations of all the road points between CF are calculated in a linear interpolation method. Accordingly, the problem of generating s relative elevation is converted into a mathematical optimization problem, so that high-quality road relative elevation data can be generated at low costs.

For a situation in which not all roads in a target area pertain to a particular overlapping road group, that is, after clustering processing, the roads in the target area may be grouped into roads in the overlapping road group and roads outside the overlapping road group, where the roads in the overlapping road group may be referred to as grouped roads and the roads outside the overlapping road group are similarly referred to as ungrouped roads. For example, FIG. 5 is a schematic diagram of a overlapping road group according to an embodiment of this application. Eight road sections in a target area in FIG. 5 are grouped into two overlapping road groups, namely, an overlapping road group 1 and a overlapping road group 2. A point A is a boundary point of the overlapping road group 1, a point B is a boundary point of the overlapping road group 2, in addition, the points A and B are also endpoints of a link4, and link4 does not pertain to any overlapping road group.

Therefore, after grouping of overlapping groups is performed on the road sections in the target area, there are still another road that does not pertain to any overlapping road group, that is, a road outside the overlapping road group (hereinafter referred to as a target road). The following describes a process for determining a relative elevation of the road outside the overlapping road group.

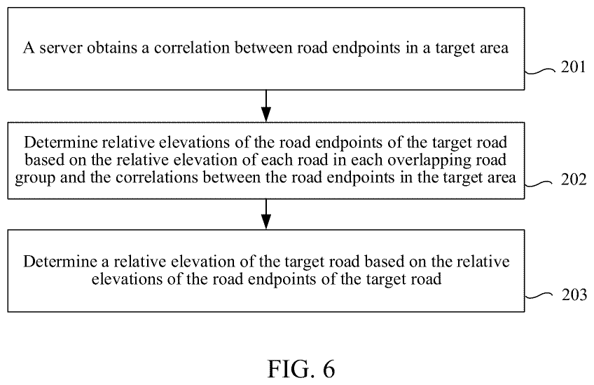

In some embodiments, FIG. 6 is a flowchart of determining a relative elevation of a target road according to an embodiment of this application. When a target road outside at least one overlapping road group exists in a target area, a server may determine a relative elevation of the target road by using the operations shown in FIG. 6.

Operation 201: A server obtains a correlation between road endpoints in a target area.

In some embodiments, the server may calculate a relative elevation of a road endpoint outside a overlapping road group according to a relative elevation of a road endpoint in the overlapping road group. The server obtains a road endpoint A of a target road in the target area, and other road endpoints B1, B2, . . . , Bn, or the like that have a correlation with the road endpoint A, where n is a quantity of road endpoints that have a correlation with the road endpoint A. The correlation here includes direct connection and indirect connection. The direct connection means that road endpoints Bj and A are two endpoints of a same road section, that is, ABj is a road section; and the indirect connection means that road endpoints Bj and A are two endpoints of at least two connected road sections, that is, AB0, B0B1, . . . , Bj−1Bj are different road sections, respectively.

Operation 202: Determine relative elevations of the road endpoints of the target road based on the relative elevation of each road in each overlapping road group and the correlations between the road endpoints in the target area.

In some embodiments, when there is at least one road endpoint Bi in the overlapping road group among B1, B2, . . . , Bn (because the road endpoint Bi is in the overlapping road group, a relative elevation of the road endpoint Bi can be calculated by the method for determining a relative elevation of a road endpoint in the overlapping road group), the server obtains a road length of a road section L including the road endpoint Bi and the relative elevation of the road endpoint Bi, and calculates a relative elevation of another road endpoint of the road section L (that is, the road endpoint A of the target road). That is, the server may determine, according to the correlation between the road endpoints in the target area and in combination with the relative elevations of the road endpoints in the overlapping road group, the relative elevations of the road endpoints of the target road outside the overlapping group and of which the relative elevation is unknown.

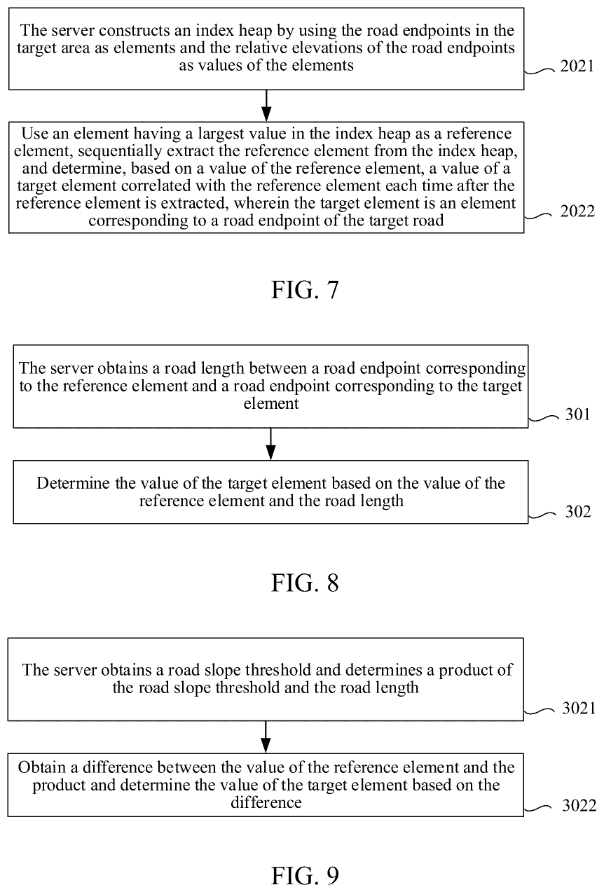

In some embodiments, FIG. 7 is a flowchart of determining a value of a target element according to an embodiment of this application. For a target road not in any overlapping road group, the server may determine a relative elevation of a road point on the target road in an interpolation method, where interpolation calculation for the relative elevation may be implemented in combination with an index heap. A description is provided in combination with the operations shown in FIG. 7.

Operation 2021: The server constructs an index heap by using the road endpoints in the target area as elements and the relative elevations of the road endpoints as values of the elements.

In some embodiments, the server creates a data structure in form of an index heap, that is, all the road endpoints in the target area are used as elements (or nodes) of the index heap, and the relative elevations of the road endpoints are used as values of the corresponding elements, to construct the corresponding index heap. Objects stored in the index heap are the road endpoints of all the road sections in the target area, and the method for comparing values of two elements in the index heap is in fact comparing relative elevations of two road endpoints. When the index heap is constructed, the relative elevations of the roads in the overlapping road group are the relative elevations calculated in the operation 101 and operation 102, and an initial value of a relative elevation of a road endpoint in a non-overlapping road group is set to 0.

Operation 2022: Use an element having a largest value in the index heap as a reference element, sequentially extract the reference element from the index heap, and determine, based on a value of the reference element, a value of a target element correlated with the reference element each time after the reference element is extracted, where the target element is an element corresponding to a road endpoint of the target road.

In some embodiments, the server inserts all the road endpoints in the target area into the index heap, sequentially extracts an element having a largest value from the index heap (that is, a road endpoint Bₘₐₓ of which a relative elevation currently is a largest value) as a reference element, and marks the road endpoint Bₘₐₓ as a known relative elevation. All edges (that is, road sections) correlated with Bₘₐₓ are obtained. For each edge (road section), if a relative elevation of another road endpoint correlated with the edge (road section) is known, the road endpoint is skipped; or otherwise, a relative elevation of another road endpoint of which the relative elevation is unknown is determined according to a length of this edge (road section) and the relative elevation of Bₘₐₓ. There are two types of elements in the index heap that are correlated with the reference elements: elements of which relative elevations are known and elements of which relative elevations are unknown. The relative elevations of the elements corresponding to the road endpoints in the overlapping road group are known, and a relative elevation of an element (that is, a target element) corresponding to a road endpoint outside the overlapping road group is unknown.

In some embodiments, FIG. 8 is a flowchart of determining a value of a target element according to an embodiment of this application. The server may alternatively determine the value of the target element correlated with the reference element in the following method.

Operation 301: The server obtains a road length between a road endpoint corresponding to the reference element and a road endpoint corresponding to the target element.

In some embodiments, the server first obtains a road length of a corresponding road section using the reference element and the target element as two road endpoints.

Operation 302: Determine the value of the target element based on the value of the reference element and the road length.

In some embodiments, FIG. 9 is another flowchart of determining a value of a target element according to an embodiment of this application. The server may alternatively determine the value of the target element in the following method.

Operation 3021: The server obtains a road slope threshold and determines a product of the road slope threshold and the road length.

For example, a calculation formula for determining the relative elevation of the target element is as follows:

$${h}_{2} = max ( {h}_{1} - S \cdot {l}_{E} , 0 ) ,$$

where

h₁ is the relative elevation of the road endpoint corresponding to the reference element, S is a preset threshold of the road slope, which generally is a tangent value of 1°, and l_{E} is the road length of the road section corresponding to the edge. To determine the relative elevation of the target element, the server obtains a road grade threshold S and determines a product S·l_{E} of the road slope threshold and the road length.

Operation 3022: Obtain a difference between the value of the reference element and the product and determine the value of the target element based on the difference.

Following the example above, the server obtains a difference that is, h₁−S·l_{E}, between the value of the reference element (that is, the relative elevation h₁ of the road endpoint corresponding to the reference element) and the product S·l_{E}. The differences are compared with 0, to obtain a difference having a largest difference with 0 as the value of the target element, that is, the target element value=max (h₁−S·l_{E}, 0), and the difference is used as the relative elevation of the road endpoint corresponding to the target element.

Operation 203: Determine a relative elevation of the target road based on the relative elevations of the road endpoints of the target road.

In some embodiments, after determining the relative elevation of the road endpoint of the target road by using the road endpoint in the overlapping road group directly or indirectly connected to the target road, the server determines a relative elevation of another road point (different from the road endpoint of the target road) in the target road based on the relative elevation of the road endpoint of the target road in an interpolation calculation method. Accordingly, the relative elevation of each road point (including the road endpoints) in the target road constitutes the relative elevation of the target road.

By applying operation 201 to operation 203, a relative elevation of a target road outside the overlapping road group in the target area is calculated, and is calculated based on the relative elevation of the road in the overlapping road group, so that the calculation accuracy of the relative elevation of the target road is ensured, and the calculation of the relative elevation of each road in the target area is implemented.

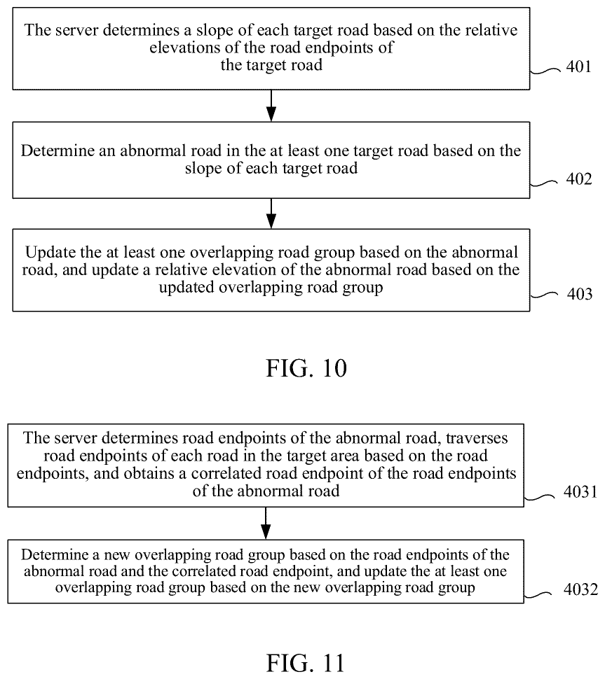

In some embodiments, FIG. 10 is a flowchart of a method for updating a relative elevation of an abnormal road according to an embodiment of this application. A description is provided in combination with the operations shown in FIG. 10.

Operation 401: The server determines a slope of each target road based on the relative elevations of the road endpoints of the target road.

In some embodiments, after the server determines the relative elevation of the target road outside the overlapping road group according to the road endpoint of which the relative elevation is known in the overlapping road group, the server may alternatively determine at least one abnormal road of which a slope does not meet a requirement in the target road by using a preset slope threshold. The calculated abnormal road only appears outside the overlapping road group. In other words, the slope and relative elevation of the road sections in the overlapping road group are correct.

Operation 402: Determine an abnormal road in the at least one target road based on the slope of each target road.

In some embodiments, the server obtains through calculation all abnormal roads of which slopes do not meet the requirement (that is, the slopes exceed the slope threshold) in the target area, and a specific implementation method includes calculating according to the relative elevations of two road endpoints correlated with the roads and lengths of the roads.

Operation 403: Update the at least one overlapping road group based on the abnormal road, and update a relative elevation of the abnormal road based on the updated overlapping road group.

In some embodiments, each road endpoint outside the overlapping road group is interpolated based on another endpoint and a road endpoint (which can be referred to as a source endpoint) based on which the road endpoint is calculated may be recorded in an interpolation process. Therefore, for any abnormal road of which a slope does not meet the requirement, correlated source endpoints are traversed back sequentially along source endpoints starting from two road endpoints correlated with the abnormal road, until a source endpoint in the overlapping road group is found; all road sections traversed and the abnormal road of which the slope does not meet the requirement at the beginning together form a new overlapping road group; and the obtained new overlapping road group and the previous overlapping road group are re-iterated, to correct a relative elevation of the abnormal road.

By applying operation 401 to operation 403, by calculating a target road slope, to look up for an abnormal road of which the slope does not meet the requirement, so as to correct the relative elevation of the abnormal road, the calculation accuracy of the relative elevation of the target road is improved.

In some embodiments, FIG. 11 is the value flowchart of determining a value of a target element according to an embodiment of this application. A quantity of the target roads is at least one, the server may alternatively update at least one overlapping road group in the following method. The following processing is performed on each abnormal road.

Operation 4031: The server determines road endpoints of the abnormal road, traverses road endpoints of each road in the target area based on the road endpoints, and obtains a correlated road endpoint of the road endpoints of the abnormal road, where

the correlated road endpoint is determined based on a source endpoint corresponding to the road endpoints of the abnormal road, and relative elevations of the road endpoints of the abnormal road are determined based on a relative elevation of the source endpoint.

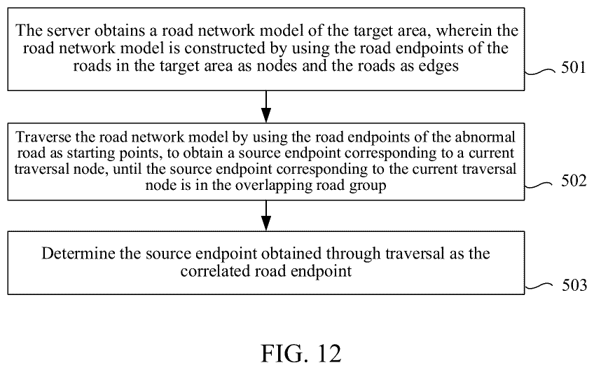

In some embodiments, FIG. 12 is a flowchart of a method for determining a correlated road endpoint according to an embodiment of this application. A specific method for obtaining, by a server, a correlated road endpoint of a road endpoint of an abnormal road is described in combination with the operations shown in FIG. 12.

Operation 501: The server obtains a road network model of the target area, where the road network model is constructed by using the road endpoints of the roads in the target area as nodes and the roads as edges.

In some embodiments, the server obtains the two-dimensional road network data of the target area, and constructs a road network model of the target area according to the two-dimensional road network data. The road network model is a two-dimensional topology model constructed by using the road endpoints of the roads in the target area as nodes and the roads as edges. That is, the edges of the road network model are each road section in the target area, and vertices of the edges of the road network model are the first and last endpoints of the road sections. If two roads are topologically connected, the two roads have a common endpoint, and the common endpoint is also a point at which an adjacency height continuity constraint is established. Therefore, each edge in the road network model is correlated with two vertices, and each vertex also records all edges correlated with the vertex. Given an edge and a vertex correlated with the edge, another vertex correlated with the edge can be obtained.

Operation 502: Traverse the road network model by using the road endpoints of the abnormal road as starting points, to obtain a source endpoint corresponding to a current traversal node, until the source endpoint corresponding to the current traversal node is in the overlapping road group.

In some embodiments, the server uses a road endpoint E of the abnormal road as a starting point, traverses the road network model, to look up for a source endpoint E1 correlated with the starting point, and continues to traverse a source endpoint E2 of the source endpoint E1 along the source endpoint E1, and so on, until a first source endpoint En pertaining to the overlapping road group is found.

Operation 503: Determine the source endpoint obtained through traversal as the correlated road endpoint.

In some embodiments, the server uses the obtained one or more source endpoints {E1, E2, . . . , En} as correlated road endpoints of the road endpoint E of the target road.

Operation 4032: Determine a new overlapping road group based on the road endpoints of the abnormal road and the correlated road endpoint, and update the at least one overlapping road group based on the new overlapping road group.

In some embodiments, the server determines all road sections formed by the road endpoints of the abnormal road and the correlated road endpoints in the target area as a new overlapping road group. Then, the initial overlapping road group is updated according to the new overlapping road group. A basic idea of dynamically adding a road section to an overlapping road group is: separately creating a new overlapping road group for the target road, and then merging the new overlapping road group into the directly connected initial overlapping road group.

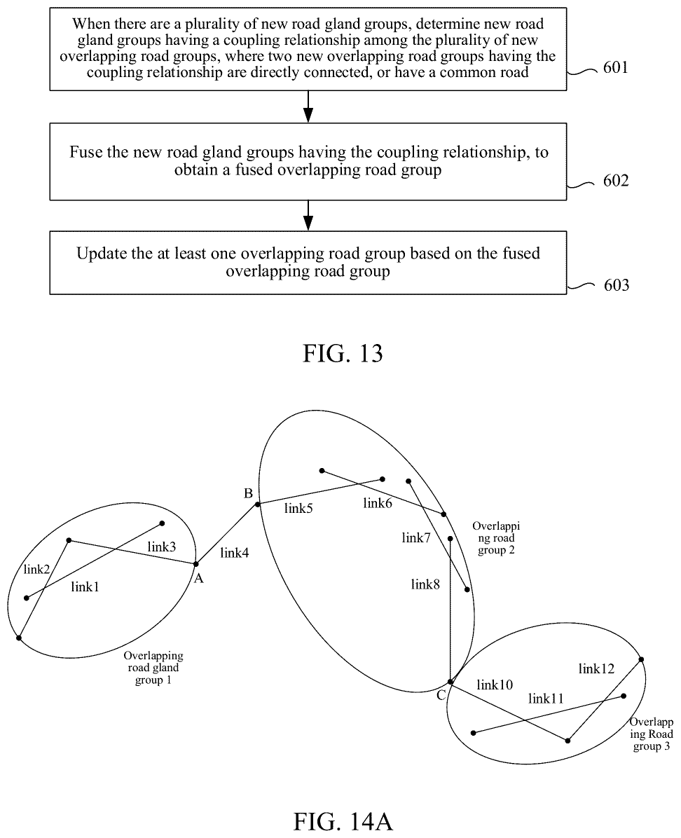

In some embodiments, FIG. 13 is a flowchart of a method for updating an overlapping road group according to an embodiment of this application. A specific method for updating an overlapping road group by a server is described in combination with the operations shown in FIG. 13.

Operation 601: When there are a plurality of new overlapping road groups, determine new overlapping road groups having a coupling relationship among the plurality of new overlapping road groups.

In some embodiments, two new overlapping road groups having the coupling relationship are directly connected, or have a common road. There may be a coupling relationship between the new overlapping group created by the server to update the relative elevation of the abnormal road and the initial overlapping group, that is, there is a road in different overlapping road groups, or there are two overlapping road groups having a common road or being directly connected to each other. When there are a plurality of new overlapping road groups, the server first determines a plurality of new overlapping road groups having a coupling relationship.

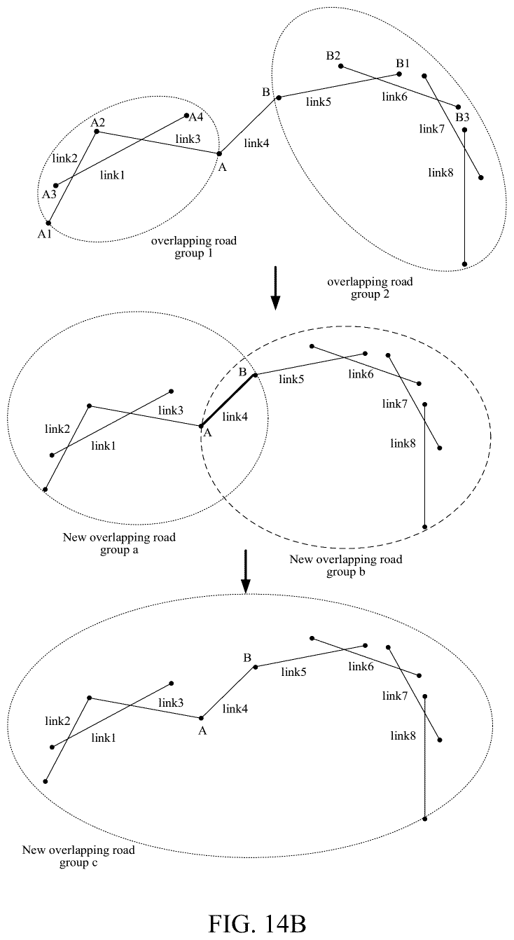

For example, FIG. 14A is a schematic diagram of directly-connected overlapping road groups according to an embodiment of this application. In FIG. 14A, the roads in the target area are grouped into three overlapping road groups, where a overlapping road group 2 and a overlapping road group 3 share a road endpoint C, and therefore, the overlapping road group 2 and the overlapping road group 3 are directly connected.

Operation 602: Fuse the new overlapping road groups having the coupling relationship, to obtain a fused overlapping road group.

In some embodiments, the server fuses the new overlapping road groups having the coupling relationship, to obtain a fused overlapping road group. That is, for the fused overlapping road group, overlapping road groups having a coupling relationship needs to be determined first.

For example, FIG. 14B is a schematic diagram of a method for fusing overlapping road groups according to an embodiment of this application. In FIG. 14B, there is an overlapping road group 1, an overlapping road group 2, and an ungrouped road section link4. The road section link4 has a road endpoint A and a road endpoint B; the link4 is directly connected to overlapping road group 1 through the road endpoint A; the link4 is directly connected to the overlapping road group 2 through the road endpoint B; a relative elevation of the road endpoint A is obtained through another road endpoint A2 of the road section link3; A2 is a road endpoint in the overlapping road group 1 and is a source endpoint of the road endpoint A. In this case, a new overlapping road group as shown in FIG. 14B can be obtained based on the road section link4 and the overlapping road group 1. In addition, because the relative elevation of the road endpoint B is determined through another road endpoint B1 of the road section link5, that is, the road endpoint B1 is a source endpoint of the road endpoint B, a new overlapping road group b shown in FIG. 14B can be obtained based on the road section link4 and the overlapping road group 2. It can be seen from FIG. 14B that the new overlapping road group a and the new overlapping road group b have a common road link4, that is, the link4 not only pertains to the new overlapping road group a, but also pertains to the new overlapping road group b. In other words, the new overlapping road group a and the new overlapping road group b still have a coupling relationship. In this case, the server continues to fuse the new overlapping road group a and the new overlapping road group b that have the coupling relationship, to obtain a new overlapping road group c as shown in FIG. 14 as a fused overlapping road group.

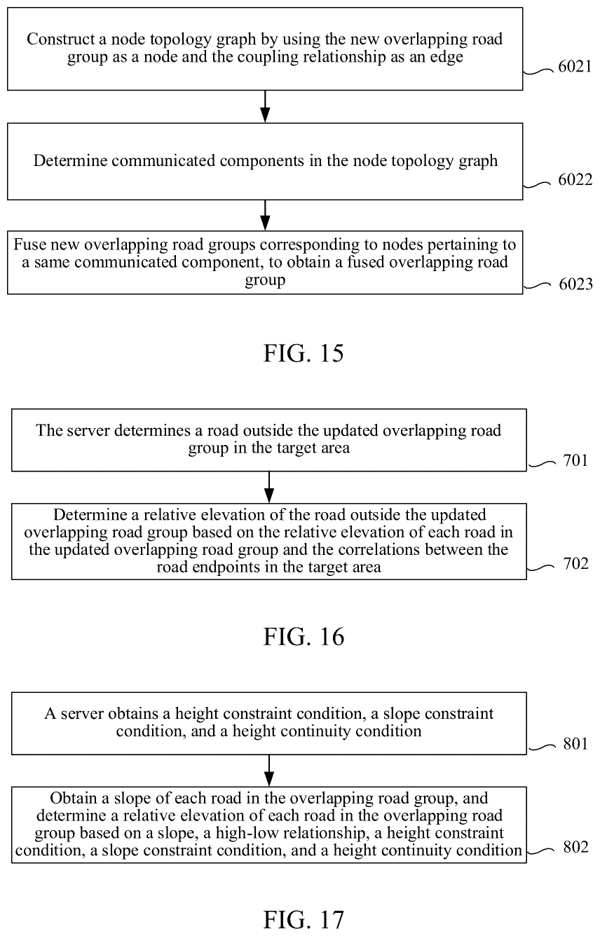

In some embodiments, FIG. 15 is the flowchart of obtaining a fused overlapping road group according to an embodiment of this application. A specific embodiment for a server to obtain a fused overlapping road group is described in combination with the operations shown in FIG. 15.

Operation 6021: Construct a node topology graph by using the new overlapping road group as a node and the coupling relationship as an edge.

In some embodiments, one overlapping road group may have coupling relationships with a plurality of overlapping road groups (directly connected or having a common road section), and therefore problem of “determining overlapping road groups having a coupling relationship” may be abstracted as a graph theory problem. In this case, the server establishes a node topology graph by using the overlapping road groups as vertices and the coupling relationships as edges. In other words, the nodes in the node topology graph are the overlapping road groups, and if two overlapping road groups have a coupling relationship, there is an edge between the nodes corresponding to the two overlapping road groups in the node topology graph.

Operation 6022: Determine communicated components in the node topology graph.

In some embodiments, the problem of clustering the overlapping road groups according to the coupling relationships is essentially a problem of calculating communicated components of an undirected graph, that is, a graph traversal problem. In the node topology graph, a node at a communicated component has a coupling relationship, because each node in the node topology graph corresponds to an overlapping road group, that is, the node at a communicated component is a overlapping road group having a coupling relationship.

Operation 6023: Fuse new overlapping road groups corresponding to nodes pertaining to a same communicated component, to obtain a fused overlapping road group.

In some embodiments, the server obtains communicated components in the node topology graph, and fuses a plurality of overlapping road groups corresponding to all the communicated components, that is, performs fusion to obtain a new overlapping road group. There are no coupling relationships between these new overlapping road groups. In other words, the overlapping road groups are clustered, to obtain a clustered fused overlapping road group. A specific method for fusing the overlapping road groups having a coupling relationship may include: for any overlapping road group, calculating a set of overlapping road groups having coupling relationships with the overlapping road group, and then fusing the overlapping road groups having the coupling relationships, to obtain a fused overlapping road group.

Operation 603: Update the at least one overlapping road group based on the fused overlapping road group.

In some embodiments, FIG. 16 is a flowchart of a method for determining a relative elevation of an ungrouped road according to an embodiment of this application. After updating the relative elevation of the abnormal road, the server may further implement the following functions.

Operation 701: The server determines a road outside the updated overlapping road group in the target area.

In some embodiments, after obtaining the ungrouped roads in the target area, the server re-establishes the relative elevation of the roads in the overlapping road group by constructing a new overlapping road group for each grouped road (usually, a new overlapping road group is separately constructed for one ungrouped road) in combination with other known overlapping road groups. Therefore, an update operation for the relative elevation of the abnormal road is implemented.

Operation 702: Determine a relative elevation of the road outside the updated overlapping road group based on the relative elevation of each road in the updated overlapping road group and the correlations between the road endpoints in the target area.

In some embodiments, after updating the overlapping road group in the target area, the server may again determine a relative elevation of each road in the updated overlapping road group, and again determine a relative elevation of a road outside the updated overlapping road group based on the correlations between road endpoints. Operation 701 and operation 702 are iteratively performed. Each time the operations are performed, the quantity of abnormal roads in the target area is reduced, and until the quantity of abnormal roads in the target area is 0, execution of the operations is stopped. In this case, a process of calculating relative elevations of all roads in the target area is completed. Accordingly, by iteratively correcting the relative elevations of the abnormal roads, the calculation accuracy of the relative elevation of the target road is improved.

By applying the embodiments of this application, a plurality of roads in a target area are grouped into a plurality of overlapping road groups according to a relative position relationship between the roads in the target area; and then, for each overlapping road group, a high-low relationship between different roads within the group is determined, and a relative elevation of a road in each overlapping road group is determined based on the high-low relationship between the different roads in each overlapping road group. Accordingly, by performing grouping of overlapping road groups on the roads in the target area and calculating a relative elevation of a road for each overlapping road group, the calculation amount and the calculation complexity for determining the relative elevation of the road are reduced. Therefore, the occupation of the calculation resources is reduced, and the efficiency of calculating the relative elevation of the road and the utilization rate of the device resources are improved.

The following describes an exemplary application of the embodiments of this application. In the related art, a unified mathematical model is established for all roads. For example, if relative elevation data of a whole XX city needs to be generated, usually a mathematical model of all roads in the whole XX city is established. Then, compared with all the roads in the city, the number of interchange roads is relatively small. In other words, the relative elevation of most of the roads in the city is 0 (that is, the roads are all on the ground). Therefore, a mathematical model including all the roads does not need to be established.

Based on this, an embodiment of this application provides a method for parallel calculation of road relative elevations. By splitting an original problem (the method for calculating relative elevations of roads based on two-dimensional road network information) into a plurality of sub-problems having no coupling relationships and designing an efficient iterative convergence strategy, the calculation efficiency of the relative elevations of the roads (that is, heights in the present specification) can be greatly improved, and the use of expensive high-performance scientific computing libraries can be avoided. After testing, road relative elevation data for use in lane-level navigation can be generated with a high efficiency, a high quality, and low costs.

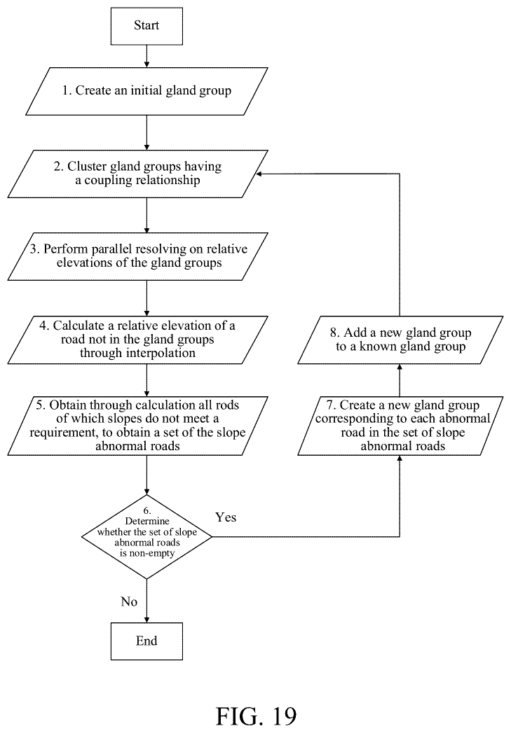

In some embodiments, FIG. 19 is a flowchart of a method for determining a relative elevation of a road according to an embodiment of this application. A server determines a relative elevation of a road through the following operations. Operation 1: Create an initial overlapping group (that is, the overlapping road group in the foregoing text). Operation 2: Cluster overlapping groups having a coupling relationship. Operation 3: Perform parallel resolving on relative elevations of the overlapping groups. Operation 4: Calculate a relative elevation of a road not in the overlapping groups through interpolation, that is, determine a relative elevation of an ungrouped road through interpolation, where the ungrouped road is the target road in the foregoing text. Operation 5: Obtain through calculation all rods of which slopes do not meet a requirement, to obtain a set of the slope abnormal roads, where the slope abnormal roads is the abnormal roads in the foregoing text. Operation 6: Determine whether the set of slope abnormal roads is non-empty; if so, operation 7 is performed, to create a new overlapping group corresponding to each abnormal road in the set of slope abnormal roads, then operation 8 is performed, to add a new overlapping group to the known overlapping group, and foregoing operation 2 is performed again; or if a result of executing operation 6 is no, the whole processing process ends.

In the foregoing processing process, grouping of overlapping groups is performed on the plurality of roads to obtain a plurality of overlapping groups, and the relative elevations of the roads in the overlapping groups are calculated based on the overlapping groups and high-low relationships of the roads in the overlapping groups at some road points. To improve the calculation efficiency, the plurality of overlapping road groups may be processed in parallel.

In some embodiments, the overlapping groups having a coupling relationship are clustered, where a graph theory model may be established when determining the overlapping groups having the coupling relationship, and a communicated component of the model can be solved based on the above. In essence, the original problem is split into a plurality of uncoupled sub-problems. This conclusion can be verified by using a disproof method, if there is a coupling relationship between two overlapping groups, the two overlapping groups pertain to a same communicated component, instead of two communicated components. Therefore, there are no coupling relationships between the overlapping groups. The plurality of uncoupled sub-problems can be solved in parallel. That is, the overlapping groups can be solved in parallel without affecting each other, and the advantages of multi-core CPU can be fully used. In addition, because a range of overlapping groups is usually small, quantities of optimization variables and constraint equations are accordingly relatively small, expensive high-performance solvers do not need to be used, and the free HSL_MA27 can meet the requirements. In practical test, the road elevations of the target areas may be grouped into a plurality of overlapping groups for solving in parallel.

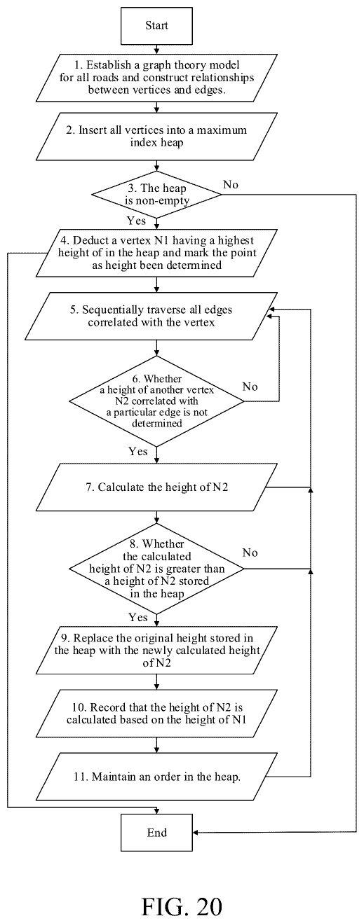

In some embodiments, for a road not in any overlapping group (that is, an ungrouped road or a road outside the overlapping group), a relative elevation of the road can be calculated in an interpolation method. The interpolation method includes the following. FIG. 20 is a schematic diagram of a method for determining an elevation through interpolation according to an embodiment of this application. A description is provided in combination with the operations shown in FIG. 20. Operation 1: First establish a graph theory model for all roads and construct relationships between vertices and edges. Operation 2: Insert all vertices into a maximum index heap. Operation 3: Is the heap non-empty; if not, end the process; or if so, perform operation 4: deduct a vertex N1 having the highest height of in the heap and mark the point as height been determined. Operation 5: Sequentially traverse all edges correlated with the vertex. Operation 6: Determine whether a height of another vertex N2 correlated with a particular edge is not determined; if not, perform operation 5; or if yes, perform operation 7: Calculate the height of N2. Operation 8: Determine whether the calculated height of N2 is greater than a height of N2 stored in the heap; if not, perform operation 5; or if yes, perform operation 9: replace the original height stored in the heap with the newly calculated height of N2. Operation 10: Record that the height of N2 is calculated from a height of N1. Operation 11: Maintain an order of the heap, and return to perform operation 5. In this processing flow, a graph theory model is first established for all the roads. The edges in the model are the roads, and the vertices in the graph are endpoints of the roads. If two roads are topologically connected, the two roads have a common endpoint, and the common endpoint is also a point at which an adjacency height continuity constraint is established. Therefore, each edge is correlated with two vertices, and each vertex also records all edges correlated with the vertex. Given an edge and a vertex correlated with the edge, another vertex correlated with the edge can be obtained. After solving the relative elevations for all the overlapping groups in parallel, for each road in the overlapping group, the heights of the two endpoints connected to the road are known, and the vertices with known heights are marked as height determined. Next, heights of other points with unknown heights are calculated starting from these vertices with known heights, to further calculate a height of each point on each road.

In some embodiments, the data structure of a maximum index heap can be used, which is an implementation of a priority queue and improves the efficiency of element exchange. Objects stored in the maximum index heap are all vertices. The method for comparing the sizes of two elements is to compare the heights of the two vertices. For a vertex in a non-overlapping group, the initial height is 0. All vertices are inserted into the maximum index heap based on the above, and a vertex currently having the highest height is sequentially taken and marked as height determined. For the vertex currently having the highest height, all edges correlated with the vertex are obtained. For each edge, if a height of another vertex correlated with the edge is determined, the edge is skipped; or otherwise, the height of another vertex is calculated according to a length of the edge and the height of the vertex. A calculation formula is as follows:

$${h}_{2} = max ( {h}_{1} - S \cdot {l}_{E} , 0 )$$

where h₁ is a height of the vertex currently having the highest height, S is a threshold of the slope, which is generally a tangent value of 1°, and l_{E} is a length of the edge, that is, the road.

In some embodiments, the calculated height is compared with the height of the point stored in the heap, and skipping is performed if the calculated height is less than or equal to the height stored in the heap; or otherwise, the calculated height is stored to the heap, which vertex the height of the point is calculated from is recorded, and then the order of the heap (for example, a shiftUp or shiftDown operation) is maintained. The above process is cycled, until there are no elements in the heap.

In some embodiments, the vertices calculated by the above method may cause the slope of some roads to exceed the threshold, and the situation needs to be detected and an iterative strategy needs to be designed to eliminate this problem. An iterative convergence strategy is as follows: each vertex not in the overlapping group is interpolated based on another vertex and a vertex (this vertex is referred to as a source vertex herein) based on which the vertex is calculated may be recorded in an interpolation process. Therefore, for any road of which a slope does not meet the requirement, source vertices are traversed back sequentially along source vertices starting from the two vertices correlated with the road, until a vertex in the overlapping group is found; all the roads traversed and the road of which the slope does not meet the requirement at the beginning together form a new overlapping group; and the newly obtained overlapping group and the previous overlapping group together enter a next round of calculation.

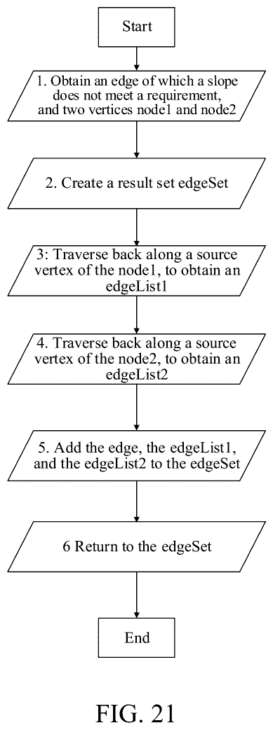

In some embodiments, FIG. 21 is an overall flowchart of a convergence strategy according to an embodiment of this application. A specific processing flow is in the following. Operation 1: Obtain an edge of which a slope does not meet a requirement, and two vertices node1 and node2. Operation 2: Create a result set edgeSet. Operation 3: Traverse back along a source vertex of the node1, to obtain an edgeList1. Operation 4: Traverse back along a source vertex of the node2, to obtain an edgeList2. Operation 5: Add the edge, the edgeList1, and the edgeList2 to the edgeSet. Operation 6: Return to the edgeSet.

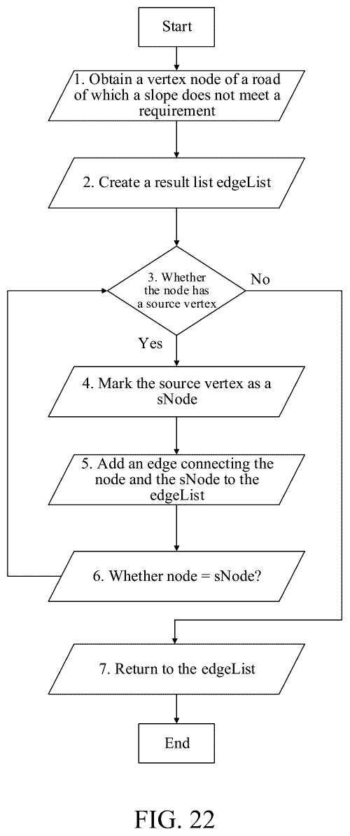

In some embodiments, FIG. 22 is a flowchart for a method for traversing back along a source endpoint according to an embodiment of this application. A specific processing flow is in the following. Operation 1: Obtain a vertex node of a road of which a slope does not meet a requirement. Operation 2: Create a result list edgeList. Operation 3: Determine whether the node has a source vertex; if not, perform operation 7: Return to the edgeList; or if yes, perform operation 4: Mark the source vertex as a sNode. Continuously, operation 5: Add an edge connecting the node and the sNode to the edgeList. Operation 6. If node=sNode, perform operation 3.

In some embodiments, there may be a coupling relationship between the new overlapping group obtained by the above method, that is, there may be a situation in which a road is located in different overlapping groups. If two overlapping groups have a common road or are directly connected, the two overlapping groups have a coupling relationship. A graph theory model may be again established, in which the vertices are overlapping groups, and if there are two overlapping groups having a coupling relationship, there is an edge that connects corresponding vertices of the two overlapping groups. For this graph theory model, communicated components are still calculated, a plurality of overlapping groups corresponding to each communicated component are fused into a new overlapping group, and if there is no coupling relationships between these new overlapping groups, a next iteration process may be turned to. Accordingly, not only the directly connected overlapping groups can be clustered, but also clustering can be performed in a case that there is a common road.

Through the embodiments of this application, the original problem is divided into several sub-problems having no coupling relationships, and in addition, an efficient iterative convergence strategy is designed, so that the calculation efficiency of the relative elevation of the road can be greatly improved and the use of expensive high-performance scientific computing libraries can be avoided. After testing, road relative elevation data for use in lane-level navigation can be generated with a high efficiency, a high quality, and low costs. The road relative elevation data can be used for rendering lane-level navigation, to produce a three-dimensional road effect.

The following continuously describes an exemplary structure of the apparatus 555 for determining a relative elevation of a road provided in the embodiments of this application as a software module. In some embodiments, as shown in FIG. 3, the software module stored in the apparatus 555 for determining a relative elevation of a road in the memory 550 may include: a grouping module 5551, configured to group a plurality of roads in a target area into at least one overlapping road group according to a relative position relationship between the roads in the target area, each of the overlapping road groups including: at least two roads in the target area having a overlapping relationship; a determining module 5552, configured to determine a high-low relationship between different roads in each overlapping road group; and a processing module 5553, configured to determine a relative elevation of each road in each overlapping road group based on the high-low relationship between the different roads in each overlapping road group by using a parallel processing mode between the overlapping road groups.

In some embodiments, the grouping module is further configured to obtain correlations between road endpoints in the target area; determine relative elevations of the road endpoints of the target road based on the relative elevation of each road in each overlapping road group and the correlations between the road endpoints in the target area; and determine a relative elevation of the target road based on the relative elevations of the road endpoints of the target road.

In some embodiments, the grouping module is further configured to construct an index heap by using the road endpoints in the target area as elements and the relative elevations of the road endpoints as values of the elements; and use an element having a largest value in the index heap as a reference element, sequentially extract the reference element from the index heap, and determine, based on a value of the reference element, a value of a target element correlated with the reference element each time after the reference element is extracted, where the target element is an element corresponding to a road endpoint of the target road.

In some embodiments, the grouping module is further configured to obtain a road length between a road endpoint corresponding to the reference element and a road endpoint corresponding to the target element; and determine the value of the target element based on the value of the reference element and the road length.

In some embodiments, the grouping module is further configured to obtain a road slope threshold and determine a product of the road slope threshold and the road length; and obtain a difference between the value of the reference element and the product and determine the value of the target element based on the difference.

In some embodiments, the grouping module is further configured to determine a slope of each target road based on the relative elevations of the road endpoints of the target road; determine an abnormal road in the at least one target road based on the slope of each target road; and update the at least one overlapping road group based on the abnormal road, and update a relative elevation of the abnormal road based on the updated overlapping road group.

In some embodiments, a quantity of the abnormal roads is at least one, and the processing module is further configured to perform the following processing on each abnormal road: determining road endpoints of the abnormal road, traversing road endpoints of each road in the target area based on the road endpoints, and obtaining a correlated road endpoint of the road endpoints of the abnormal road, where the correlated road endpoint is determined based on a source endpoint corresponding to the road endpoints of the abnormal road, and relative elevations of the road endpoints of the abnormal road are determined based on a relative elevation of the source endpoint; and determining a new overlapping road group based on the road endpoints of the abnormal road and the correlated road endpoint, and updating the at least one overlapping road group based on the new overlapping road group.

In some embodiments, the processing module is further configured to obtain a road network model of the target area, where the road network model is constructed by using the road endpoints of the roads in the target area as nodes and the roads as edges; traverse the road network model by using the road endpoints of the abnormal road as starting points, to obtain a source endpoint corresponding to a current traversal node, until the source endpoint corresponding to the current traversal node is in the overlapping road group; and determine the source endpoint obtained through traversal as the correlated road endpoint.

In some embodiments, the processing module is further configured to: when there are a plurality of new overlapping road groups, determine new overlapping road groups having a coupling relationship among the plurality of new overlapping road groups, where two new overlapping road groups having the coupling relationship are directly connected, or have a common road; fuse the new overlapping road groups having the coupling relationship, to obtain a fused overlapping road group; and update the at least one overlapping road group based on the fused overlapping road group.

In some embodiments, the processing module is further configured to construct a node topology graph by using the new overlapping road group as a node and the coupling relationship as an edge; determine communicated components in the node topology graph; and fuse new overlapping road groups corresponding to nodes pertaining to a same communicated component, to obtain a fused overlapping road group.

In some embodiments, the processing module is further configured to determine a road outside the updated overlapping road group in the target area; and determine a relative elevation of the road outside the updated overlapping road group based on the relative elevation of each road in the updated overlapping road group and the correlations between the road endpoints in the target area.

In some embodiments, the processing module is further configured to determine a relative elevation of each road in each overlapping road group based on the high-low relationship between the different roads in each overlapping road group by using a parallel processing method between the overlapping road groups.

In some embodiments, the processing module is further configured to perform the following processing on each of the overlapping road groups: obtaining a height constraint condition, a slope constraint condition, and a height continuity condition, where the height constraint condition is configured for indicating a condition that an elevation difference between different roads needs to meet; the slope constraint condition is configured for indicating a condition that a slope of each road needs to meet; the height continuity condition is configured for indicating a condition that continuity of adjacent roads needs to meet; and obtaining the slope of each road in the overlapping road group, and determining the relative elevation of each road in the overlapping road group based on the slope, the high-low relationship, the height constraint condition, the slope constraint condition, and the height continuity condition.

An embodiment of this application provides a computer program product, the computer program product including a computer program or a computer-executable instruction, and the computer program or the computer-executable instruction being stored in a computer-readable storage medium. A processor of an electronic device reads the computer-executable instruction from the computer-readable storage medium, and the processor executes the computer-executable instruction, so that the electronic device performs the method for determining a relative elevation of a road provided in the foregoing embodiments of this application.

An embodiment of this application provides a computer-readable storage medium, having a computer-executable instruction stored therein, and the computer-executable instruction, when executed by a processor, causing the processor to perform the method for determining a relative elevation of a road provided in the foregoing embodiments of this application, for example, the method for determining a relative elevation of a road shown in FIG. 3.

In some embodiments, the computer-readable storage medium may be a memory such as an FRAM, a ROM, a PROM, an EPROM, an EEPROM, a flash memory, a magnetic surface memory, an optical disc, or a CD-ROM; or may be various devices including one or any combination of the foregoing memories.

In some embodiments, the computer-executable instruction may be in a form of a program, software, a software module, scripts, or code, written in any form of programming language (including compiling or interpreting languages, or declarative or procedural languages), and may be deployed in any form, including being deployed as a stand-alone program or as a module, a component, a subroutine, or another unit suitable for use in a computing environment.

For example, the computer-executable instructions may, but do not necessarily, correspond to a file in a file system, may be stored as part of a file holding other programs or data, for example, in one or more scripts stored in a hypertext markup language (HTML) document, in a single file exclusively used in a program in question, or in a plurality of collaborative files (for example, files having one or more modules, subroutines, or code portions stored therein).

For example, the executable instruction may be deployed for execution on one electronic device, or on a plurality of electronic devices located at one location, or on a plurality of electronic devices distributed at a plurality of locations and interconnected via a communication network.

In summary, through the embodiments of this application, the original problem is divided into several sub-problems having no coupling relationships, and in addition, an efficient iterative convergence strategy is designed, so that the calculation efficiency of the relative elevation of the road can be greatly improved and the costs can be saved.

The foregoing descriptions are merely preferred embodiments of this application and are not intended to limit the protection scope of this application. Any modification, equivalent replacement, or improvement made without departing from the spirit and principle of this application shall fall within the protection scope of this application.

What is claimed is:

1. A method for determining a relative elevation of a road, applied to an electronic device, the method comprising:
grouping a plurality of roads in a target area into at least one overlapping road group according to a relative position relationship between the roads in the target area, each of the overlapping road groups comprising at least two roads in the target area having an overlapping relationship;
determining a high-low relationship between different roads in each overlapping road group; and
determining a relative elevation of each road in each overlapping road group based on the high-low relationship between the different roads in each overlapping road group.

2. The method according to claim 1, wherein when there is a target road outside the at least one overlapping road group in the target area, the method further comprises:
obtaining correlations between road endpoints in the target area;
determining relative elevations of the road endpoints of the target road based on the relative elevation of each road in each overlapping road group and the correlations between the road endpoints in the target area; and
determining a relative elevation of the target road based on the relative elevations of the road endpoints of the target road.

3. The method according to claim 2, wherein the determining relative elevations of the road endpoints of the target road based on the relative elevation of each road in each overlapping road group and the correlations between the road endpoints in the target area comprises:
constructing an index heap by using the road endpoints in the target area as elements and the relative elevations of the road endpoints as values of the elements; and
using an element having the largest value in the index heap as a reference element, sequentially extracting the reference element from the index heap, and determining, based on a value of the reference element, a value of a target element correlated with the reference element each time after the reference element is extracted, wherein
the target element is an element corresponding to a road endpoint of the target road.

4. The method according to claim 3, wherein the determining, based on a value of the reference element, a value of a target element correlated with the reference element each time after the reference element is extracted comprises:
obtaining a road length between a road endpoint corresponding to the reference element and a road endpoint corresponding to the target element; and
determining the value of the target element based on the value of the reference element and the road length.

5. The method according to claim 4, wherein the determining the value of the target element based on the value of the reference element and the road length comprises:
obtaining a road slope threshold and determining a product of the road slope threshold and the road length; and
obtaining a difference between the value of the reference element and the product and determining the value of the target element based on the difference.

6. The method according to claim 2, wherein a quantity of target roads is at least one, and after the determining relative elevations of the road endpoints of the target road, the method further comprises:
determining a slope of each target road based on the relative elevations of the road endpoints of the target road;
determining an abnormal road in the at least one target road based on the slope of each target road; and
updating the at least one overlapping road group based on the abnormal road, and updating a relative elevation of the abnormal road based on the updated overlapping road group.

7. The method according to claim 6, wherein a quantity of abnormal roads is at least one, and the updating the at least one overlapping road group based on the abnormal road comprises:
respectively executing following processing on each abnormal road:
determining road endpoints of the abnormal road, traversing road endpoints of each road in the target area based on the road endpoints, and obtaining a correlated road endpoint of the road endpoints of the abnormal road, wherein
the correlated road endpoint is determined based on a source endpoint corresponding to the road endpoints of the abnormal road, and relative elevations of the road endpoints of the abnormal road are determined based on a relative elevation of the source endpoint; and
determining a new overlapping road group based on the road endpoints of the abnormal road and the correlated road endpoint, and updating the at least one overlapping road group based on the new overlapping road group.

8. The method according to claim 7, wherein the traversing road endpoints of each road in the target area based on the road endpoints, and obtaining a correlated road endpoint of the road endpoints of the abnormal road comprises:
obtaining a road network model of the target area, wherein the road network model is constructed by using the road endpoints of the roads in the target area as nodes and the roads as edges;
traversing the road network model by using the road endpoints of the abnormal road as starting points, to obtain a source endpoint corresponding to a current traversal node, until the source endpoint corresponding to the current traversal node is in the overlapping road group; and
determining the source endpoint obtained through traversal as the correlated road endpoint.

9. The method according to claim 7, wherein the updating the at least one overlapping road group based on the new overlapping road group comprises:
when there are a plurality of new overlapping road groups, determining new overlapping road groups having a coupling relationship among the plurality of new overlapping road groups, wherein
two new overlapping road groups having the coupling relationship are directly connected, or have a common road;
fusing the new overlapping road groups having the coupling relationship, to obtain a fused overlapping road group; and
updating the at least one overlapping road group based on the fused overlapping road group.

10. The method according to claim 9, wherein the fusing the new overlapping road groups having the coupling relationship, to obtain a fused overlapping road group comprises:
constructing a node topology graph by using the new overlapping road group as a node and the coupling relationship as an edge;
determining communicated components in the node topology graph; and
fusing new overlapping road groups corresponding to nodes pertaining to a same communicated component, to obtain a fused overlapping road group.

11. The method according to claim 6, wherein after the updating the relative elevation of the abnormal road, the method further comprises:
determining a road outside the updated overlapping road group in the target area; and
determining a relative elevation of the road outside the updated overlapping road group based on the relative elevation of each road in the updated overlapping road group and the correlations between the road endpoints in the target area.

12. The method according to claim 1, wherein the determining a relative elevation of each road in each overlapping road group based on the high-low relationship between the different roads in each overlapping road group comprises:
determining a relative elevation of each road in each overlapping road group based on the high-low relationship between the different roads in each overlapping road group by using a parallel processing method between the overlapping road groups.

13. The method according to claim 1, wherein the determining a relative elevation of each road in each overlapping road group based on the high-low relationship between the different roads in each overlapping road group comprises:
respectively executing following processing on each overlapping road group:
obtaining a height constraint condition, a slope constraint condition, and a height continuity condition, wherein
the height constraint condition is configured for indicating a condition that an elevation difference between different roads needs to meet; the slope constraint condition is configured for indicating a condition that a slope of each road needs to meet; the height continuity condition is configured for indicating a condition that continuity of adjacent roads needs to meet; and
obtaining the slope of each road in the overlapping road group, and determining the relative elevation of each road in the overlapping road group based on the slope, the high-low relationship, the height constraint condition, the slope constraint condition, and the height continuity condition.

14. An electronic device, the electronic device comprising:
a memory, configured to store a computer-executable instruction; and
a processor, configured to implement, when executing the computer-executable instruction stored in the memory, a method for determining a relative elevation of a road, applied to an electronic device, the method comprising:
grouping a plurality of roads in a target area into at least one overlapping road group according to a relative position relationship between the roads in the target area, each of the overlapping road groups comprising at least two roads in the target area having an overlapping relationship;
determining a high-low relationship between different roads in each overlapping road group; and
determining a relative elevation of each road in each overlapping road group based on the high-low relationship between the different roads in each overlapping road group.

15. The electronic device according to claim 14, wherein when there is a target road outside the at least one overlapping road group in the target area, the method further comprises:
obtaining correlations between road endpoints in the target area;
determining relative elevations of the road endpoints of the target road based on the relative elevation of each road in each overlapping road group and the correlations between the road endpoints in the target area; and
determining a relative elevation of the target road based on the relative elevations of the road endpoints of the target road.

16. The electronic device according to claim 15, wherein the determining relative elevations of the road endpoints of the target road based on the relative elevation of each road in each overlapping road group and the correlations between the road endpoints in the target area comprises:
constructing an index heap by using the road endpoints in the target area as elements and the relative elevations of the road endpoints as values of the elements; and
using an element having the largest value in the index heap as a reference element, sequentially extracting the reference element from the index heap, and determining, based on a value of the reference element, a value of a target element correlated with the reference element each time after the reference element is extracted, wherein
the target element is an element corresponding to a road endpoint of the target road.

17. A non-transitory computer-readable storage medium, having a computer-executable instruction stored therein, and the computer-executable instruction, when executed by a processor, implementing a method for determining a relative elevation of a road, applied to an electronic device, the method comprising:
grouping a plurality of roads in a target area into at least one overlapping road group according to a relative position relationship between the roads in the target area, each of the overlapping road groups comprising at least two roads in the target area having an overlapping relationship;
determining a high-low relationship between different roads in each overlapping road group; and
determining a relative elevation of each road in each overlapping road group based on the high-low relationship between the different roads in each overlapping road group.

18. The computer-readable storage medium according to claim 17, wherein when there is a target road outside the at least one overlapping road group in the target area, the method further comprises:
obtaining correlations between road endpoints in the target area;
determining relative elevations of the road endpoints of the target road based on the relative elevation of each road in each overlapping road group and the correlations between the road endpoints in the target area; and
determining a relative elevation of the target road based on the relative elevations of the road endpoints of the target road.

19. The computer-readable storage medium according to claim 18, wherein the determining relative elevations of the road endpoints of the target road based on the relative elevation of each road in each overlapping road group and the correlations between the road endpoints in the target area comprises:
constructing an index heap by using the road endpoints in the target area as elements and the relative elevations of the road endpoints as values of the elements; and
using an element having the largest value in the index heap as a reference element, sequentially extracting the reference element from the index heap, and determining, based on a value of the reference element, a value of a target element correlated with the reference element each time after the reference element is extracted, wherein
the target element is an element corresponding to a road endpoint of the target road.

20. The computer-readable storage medium according to claim 18, wherein the determining, based on a value of the reference element, a value of a target element correlated with the reference element each time after the reference element is extracted comprises:
obtaining a road length between a road endpoint corresponding to the reference element and a road endpoint corresponding to the target element; and
determining the value of the target element based on the value of the reference element and the road length.
